(19) United States
(12) Patent Application Publication
(10) Pub. No.: US 2022/0002178 A1
(43) Pub. Date: Jan. 6, 2022

(54) DEVICE FOR DRYING SEWAGE SLUDGE

(71) Applicant: l+M GmbH & Co. KG Innovation und Management, Balingen-Zillhausen (DE)

(72) Inventor: Richard ZIZMANN, Balingen-Zillhausen (DE)

(21) Appl. No.: 17/311,187

(22) PCT Filed: Nov. 18, 2019
(86) PCT No.: PCT/DE2019/100989

§ 371 Date: Jun. 4, 2021

(30) Foreign Application Priority Data
Dec. 20, 2018 (DE) 10 2018 133 070.7

(51) Int. Cl. C02F 11/123; C02F 11/16

(52) U.S. Cl. CPC C02F 11/123; C02F 2201/007; C02F 11/16

(57) ABSTRACT

A device for drying sewage sludge having a modular design composed of standard containers, the standard containers being disposed behind and optionally on top of one another. Slabs including heating lines are introduced on top of one another, in multiple levels, into the standard containers, serving as drying surfaces. Linear conveyors including deflections in a first and a last container distribute the sewage sludge across a width of the drying surfaces, turn and loosen the sewage sludge, and move this successively back and forth over the drying surfaces disposed on top of one another.

### TECHNICAL FIELD

The invention relates to a device for drying, in particular, sewage sludge. The device is generally suitable for drying bulk materials and viscous substances that do not spread, or spread only to a limited extent, on a horizontal surface as a result of gravity.

### DESCRIPTION OF RELATED ART

International patent application WO 2008/092 374 A1 describes a multi-level device for drying sewage sludge, comprising trays that are disposed on top of one another, the top sides of which form drying surfaces for applying and spreading sewage sludge. The trays are hollow for the passage of a heating means. A belt conveyor is disposed above each tray, which conveys the sewage sludge from one end to an opposite end above the trays. At the end, the sewage sludge drops through an opening onto the next drying surface located therebeneath, the belt conveyor of which conveys the sewage sludge in the opposite direction.

### SUMMARY OF THE INVENTION

It is the object of the invention to provide a device for drying, in particular, sewage sludge, comprising multiple drying surfaces that are disposed on top of one another, having a simple and variable design.

The device according to the invention for drying, in particular, sewage sludge comprises drying surfaces which are disposed on top of one another and onto which the sewage sludge can be placed for drying. The drying surfaces are preferably horizontal and can have an inclination, which is so small that the sewage sludge does not flow solely as a result of gravity across the drying surfaces. The device according to the invention preferably comprises an even number of, which is to say two or an integral multiple of two, drying surfaces disposed on top of one another, so that sewage sludge or the like can be conveyed, for drying purposes, by way of a revolving linear conveyor on a drying surface in one direction, and on another drying surface back in an opposite direction. An odd number of drying surfaces disposed on top of one another, however, is not precluded.

In addition, the device comprises one or more revolving linear conveyors, in each case for two of the drying surfaces disposed on top of one another. A linear conveyor for a drying surface is, in particular, possible with an odd number of drying surfaces disposed on top of one another. Drying surfaces assigned to a linear conveyor are preferably disposed directly on top of one another, which is to say without a further drying level therebetween. However, the drying surfaces assigned to a linear conveyor do not necessarily have to be directly and/or congruently disposed on top of one another. The linear conveyor comprises conveying elements, such as pegs, paddles, blades or plows, which are moved in a longitudinal direction over the drying surfaces, essentially “plowing through” the sewage sludge on the drying surfaces and distributing this across a width and a length of the drying surfaces, loosening and turning the sewage sludge, and conveying the sewage sludge successively in the longitudinal direction over the drying surfaces. The conveying elements can make contact with the drying surfaces, and are preferably distanced, for example by one or several millimeters, from the drying surfaces, the distance being so small that these project into the sewage sludge.

“Revolving” shall be understood to mean a linear conveyor comprising one or more continuous, flexible traction means, such as chains or ropes, which are preferably deflected at the ends of the drying surfaces so that, in particular, a respective strand extends in the longitudinal direction over one of the two drying surfaces disposed on top of one another, so that the traction means are able to move the conveying elements in the longitudinal direction over the drying surfaces.

In particular, the sewage sludge is placed onto an uppermost drying surface at one end, for example poured, pushed or pulled onto the drying surface and successively conveyed by the linear conveyor to the other end of the uppermost drying surface, where the sewage sludge drops onto one end of a subsequent drying surface disposed beneath, and is successively conveyed back in the opposite direction by the linear conveyor over this drying surface. At the end of a lowermost drying surface, the sewage sludge falls out of or is removed from the device. During the conveying over the drying surfaces, the sewage sludge is distributed, turned, loosened and dried, as described.

According to the invention, the device is subdivided into modules, which are disposed behind one another in the longitudinal direction, wherein the modules disposed behind one another preferably adjoin one another without a distance. Each module comprises the drying surfaces, or an even or odd number of the drying surfaces, of the device, wherein, to be precise, the modules comprise portions of the drying surfaces of the device. The linear conveyor extends, or the linear conveyors extend, through the modules disposed behind one another and comprise a deflection in a first module and in a last module, so that the linear conveyor extends, or strands of the linear conveyor extend, in the longitudinal direction over the drying surfaces disposed on top of one another, so as to successively convey the sewage sludge in the longitudinal direction, through all the modules, over the drying surfaces disposed on top of one another.

The number of the modules disposed behind one another, and thus the length of the device and of the drying surfaces, is variable. The modules can be easily set up on strip foundations or pad foundations, for example. In addition, the device according to the invention is variable in terms of the location, as a result of the modular design thereof, and the modules can, in particular, be transported on trucks.

Multiple modules can be disposed on top of one another, whereby the number of drying surfaces disposed on top of one another can be increased, and the length of the device can be shortened for a given total length of the drying surfaces.

The modules preferably comprise standard containers, and in particular ISO containers. This means that the modules comprise standardized container corners at locations provided by the standard, at which these can be attached to trucks, for example, for ISO or standard containers. Supports for tines of forklift trucks provided for standard containers can be present. The modules can, for example, comprise braces for connecting the container corners, the drying surfaces and the linear conveyor or conveyors. The modules preferably comprise walls, a ceiling and/or a floor at the locations provided for standard containers, which is to say the modules have the shape of rectangular tubes, in which the drying surfaces, or portions of the drying surfaces, and the linear conveyor or conveyors are disposed or, in any case, devices for attaching the linear conveyor or conveyors are disposed. The containers can be disposed behind one another so as to abut one another, creating a long rectangular tube in which the drying surfaces, situated on top of one another, and the linear conveyor or conveyors are located. As described, the containers can also be placed on top of one another, resulting in more drying surfaces on top of one another and requiring fewer containers to be placed on top of one another.

For example, the conveying elements of the linear conveyor or conveyors are, as described, pegs, paddles, blades or plows that are attached to cross beams, for example, which extend transversely across a width of the drying surfaces, which are guided, for example in a sliding or rolling manner, on rails in the longitudinal direction of the drying surfaces, and which are moved by way of one or more traction means, such as ropes or chains, in the longitudinal direction over the drying surfaces. At the ends of the drying surfaces, which is to say in the first and last modules, the traction means are deflected, for example, about sheaves or sprockets, serving as deflection wheels or, generally speaking, deflections. The cross beams are deflected by way of the traction means. The cross beams are located at a distance above the drying surfaces, and the conveying elements project upwardly and downwardly from the cross beams. Multiple conveying elements are disposed at a distance next to one another at each cross beam. The conveying elements are narrower than the drying surfaces and preferably only take up a fraction of the width of the drying surfaces. The conveying elements are preferably distributed over the width of the drying surfaces on several cross beams in such a way that the conveying elements of one cross beam are located in gaps between the conveying elements of another cross beam.

During movement of the cross beams by way of the traction means in the longitudinal direction over the drying surfaces, the conveying elements “plow through” the sewage sludge on the drying surfaces, sewage sludge being pushed successively, which is to say a certain distance at a time, by the conveying elements in the longitudinal direction and laterally by the width of the conveying elements toward the side, over the drying surfaces, until the sewage sludge remains in place in a new position, laterally next to the particular conveying element, on the drying surfaces. Conveying elements of subsequent cross beams continue to move the sewage sludge which initially remained in place, which is to say move the sewage sludge again a certain distance in the longitudinal direction over the drying surfaces and laterally by the width of the conveying element toward the side. At the same time, the conveying elements turn and loosen the sewage sludge. The foregoing description of the conveying elements of the linear conveyor or conveyors is provided by way of example and serves for illustrative purposes. Other designs of the linear conveyor or conveyors, with or without conveying elements, are possible.

In a preferred embodiment of the invention, the drying surfaces comprise a heating device. For example, heating lines are provided beneath the drying surfaces, for conducting a liquid or gaseous heating means in heat-conducting contact. According to one embodiment of the invention, the drying surfaces are subdivided in the longitudinal direction, and the heating lines are connected in a fluid-tight manner to sleeves or corrugated pipes, for example, at the subdivision areas of the drying surfaces. Due to the modular design, the drying surfaces are interrupted, in particular at a front end and a rear end of the modules or standard containers in the longitudinal direction of the drying surfaces. In addition, the drying surfaces can be interrupted within the modules or standard containers, so that the individual drying surfaces are small and lightweight. A detachable arrangement of the drying surfaces in the modules or standard containers is possible, so that the drying surfaces can be transported separately from the modules or standard containers. At the set-up location, the drying surfaces are disposed in the modules or standard containers, and the heating lines are connected.

According to one embodiment of the invention, the drying surfaces comprise slabs, the upper sides of which form the drying surfaces. The slabs can be made of concrete and can comprise a reinforcement for strengthening, or can be configured as comparable heat-conducting heating plates. The slabs may be strengthened by a rust-proof reinforcement made of glass fibers, stone fibers or other fibers or rods, for example. A rust-proof reinforcement has the advantage that a covering of the reinforcement can be thin, and the slabs can thus be thin and lightweight.

In a preferred embodiment of the invention, the drying surfaces comprise a heating device in the form of a heatable plate. For example, heating lines are provided beneath and/or within the slab, for conducting a liquid or gaseous heating means in heat-conducting contact. In the case of a non-modular embodiment of the drying surfaces, fluid-tight connections, for example by way of sleeves or corrugated pipes, are located at the start and end of a continuously heated plate surface. According to another embodiment of the invention, the drying surfaces can be subdivided in the longitudinal direction so as to satisfy the modular design nature. In the case of a modular design, the heated plate is subdivided into several individual plates. The connection of the heating lines of the plate modules at the start and end of every plate module is achieved in a fluid-tight manner.

According to one embodiment of the invention, the drying surfaces comprise slabs including one or more binding girders for stiffening. This also enables thin, and thus lightweight, slabs. The binding girders can extend longitudinally, transversely and/or obliquely with respect to the longitudinal direction of the drying surfaces. The slabs, the upper sides of which form the drying surfaces, can comprise one or more binding girders and a reinforcement.

According to one embodiment of the invention, the first module or the first standard container comprises a loading point and/or a discharge point for the sewage sludge. A module at one end of the modules disposed behind one another in which the sewage sludge is placed onto an uppermost drying surface and/or is removed or drops from a lowermost drying surface is referred to as a first module. Since the sewage sludge is conveyed in one direction over a drying surface and back over a drying surface located therebeneath, the loading point and the discharge point can be located in one module or standard container. If modules are disposed on top of one another, the loading point is located in an upper module, and the discharge point in a lower module. The loading point can be an opening in the top of a module, for example, through which the sewage sludge is poured onto the uppermost drying surface or placed thereon in another manner. The discharge point can likewise be an opening at an end, a side, or at the bottom of a module, for example, through which the sewage sludge drops from one end of a lowermost drying surface. The discharge point can also comprise a conveying means, such as a worm for removing the sewage sludge from the lowermost drying surface.

A module at one end of the modules disposed behind one another in which the sewage sludge is placed onto a first drying surface is referred to as a first module. The sewage sludge is conveyed on this drying surface by way of conveying elements until transferred or discharged onto the next drying surface. The second drying surface can be located beneath the first drying surface or adjoin horizontally in a second module. Since the sewage sludge is conveyed in one direction over a drying surface and back over a drying surface located therebeneath, the loading point and the discharge point can be located in one module or standard container. If modules are disposed on top of one another, the loading point is located in an upper module, and the discharge point in a lower module. The loading point can be an opening in the top of a module, for example, through which the sewage sludge is poured onto the uppermost drying surface or placed thereon in another manner. The discharge point can likewise be an opening at an end, a side, or at the bottom of a module, for example, through which the sewage sludge drops from one end of a lower drying surface. The discharge point can also comprise a conveying means, such as a worm for removing the sewage sludge from the lowermost drying surface.

A module between the first and last modules is referred to as an intermediate module. A variable number of intermediate modules can be installed between the first and last modules so as to increase the drying surfaces and the sludge throughput. In the case of a longitudinal construction, the fronts of the container are removed to ensure that the sewage sludge is transferred on the respective drying surfaces of the modules. In the case of a stacked construction, one opening is created in the bottom of the discharging container, and one is created in the roof of the receiving container in the region of the discharge point or loading point.

A module that is only in contact on one side with one or more drying surfaces of a first module or of an intermediate module is referred to as a last module. It is joined horizontally or vertically at the opposite end of the first module. The last module can, but does not have to, include a discharge point.

All of the features mentioned in the description and/or shown in the drawings can be implemented individually, alone, or in any arbitrary combination, in embodiments of the invention. Embodiments of the invention that do not comprise all, but only some of the features of a claim, including of the independent claim, are possible.

### BRIEF DESCRIPTION OF THE DRAWINGS

The invention will be described hereafter in greater detail based on one exemplary embodiment shown in the drawings. In the drawings:

FIG. 1 shows a device according to the invention in a side view;

FIG. 2 shows a side view of a module of the device from FIG. 1; and

FIG. 3 shows a front view of a module of the device from FIG. 1.

The drawings are simplified schematic illustrations to provide an understanding of the invention and to describe the same.

### DETAILED DESCRIPTION OF THE INVENTION

The device 1 according to the invention shown in the drawings for drying sewage sludge has a modular design and comprises standardized, so-called ISO containers 2, serving as modules 3, which are disposed behind one another in a longitudinal direction L. Containers 2 or modules 3 can also be disposed on top of one another in the form of levels, whereby a length of the device 1 is shortened. In the exemplary embodiment, two containers 2 at a time are placed on top of one another. Bottom containers 2 are placed onto strip foundations 4, for example.

The containers 2 forming the modules 3 comprise standardized container corners 5, at which the containers 2, which are disposed behind and on top of one another, are mutually connected.

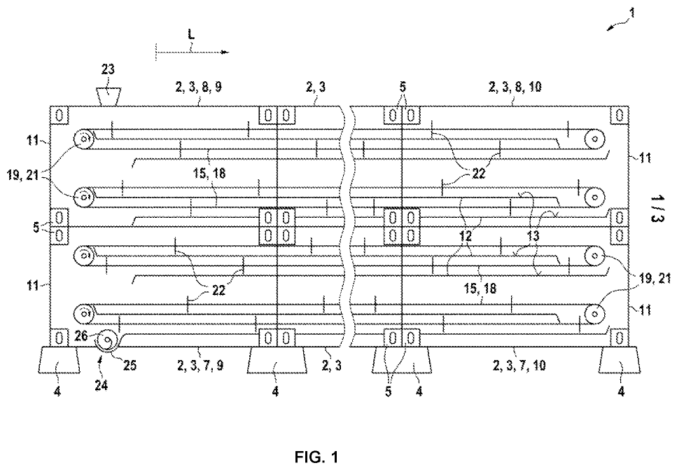

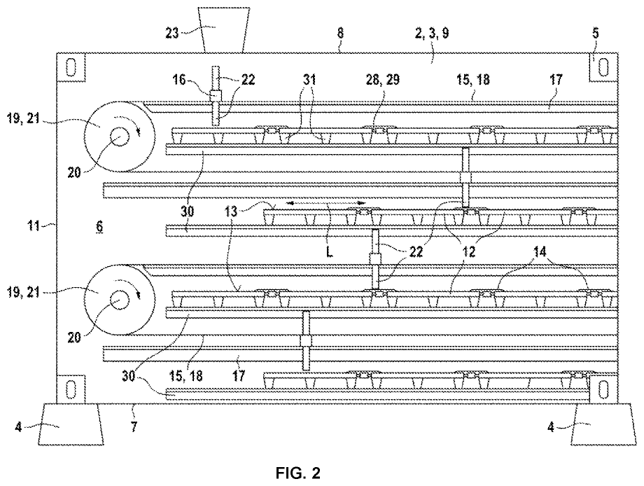

In addition, the containers 2 comprise (longitudinal) side walls 6, a floor 7 and a ceiling 8, which is to say the containers 2 disposed behind one another have the shape of a rectangular tube. A first container 9 and a last container 10 of the containers 2 disposed behind one another comprise an end wall 11. Side walls 6 facing an observer are not shown in FIGS. 1 and 2, so that installations in the containers 2 or modules 3 of the device 1 are visible.

One or more slabs 12 are disposed in each container 2. If only one slab 12 is disposed in a container 2, this may be disposed horizontally, which is to say parallel to the floor 7 and the ceiling 8 of the container 2, or obliquely in the container 2. If multiple slabs 12 are disposed in a container 2, the slabs 12 are disposed horizontally, which is to say parallel to the floor 7 and the ceiling 8 of the container 2, in the container 2. Upper sides of the slabs 12 form the drying surfaces 13. Multiple slabs 12 are disposed behind one another in the longitudinal direction L in each container 2, and intermediate spaces between the slabs 12 are bridged by metal sheets 14, so that the drying surfaces 13 extend continuously through all of the containers 2 disposed behind one another.

One to four slabs 12 are disposed on top of one another in each of the containers 2 forming the modules 3 of the device 1 according to the invention, so that the device 1 on each level comprises four drying surfaces 13 on top of one another. If the device 1, as a result of containers 2 being disposed on top of one another, comprises multiple levels, the number of drying surfaces 13 increases accordingly. Containers comprising two, six, eight or more drying surfaces 13 disposed on top of one another are also possible. While the invention does not preclude an odd number of drying surfaces 13 disposed on top of one another, an even number of drying surfaces 13 disposed on top of one another is preferred, so that the sewage sludge can always be conveyed back and forth.

The device 1 according to the invention comprises a respective linear conveyor 15 for two or more of the drying surfaces 13 disposed on top of one another, which at one end distributes sewage sludge that has been placed onto an upper drying surface 13 across a width B of the drying surface 13, loosens and turns the sewage sludge, and conveys this to the other end of the drying surface 13. At the other end of the upper drying surfaces 13, the sewage sludge drops onto a drying surface 13 disposed therebeneath, where the same linear conveyor 15 again loosens, turns and conveys the sewage sludge back to the one end of the drying surface 13. There, the sewage sludge again drops onto a drying surface 13 disposed therebeneath, on which the sewage sludge is conveyed by another linear conveyor 13 back to the other end and, on a further drying surface 13 disposed therebeneath, back to the one end. At the end of a lowermost drying surface 13, the sewage sludge is removed from the device 1 in the dry state. A linear conveyor 15 that only conveys the sewage sludge over one drying surface 13, or over more than two drying surfaces 13, is also conceivable.

In the exemplary embodiment, the linear conveyors 15 are continuous-flow conveyors comprising cross beams 16 that extend transversely across the width B of the containers 2 and the drying surfaces 13 and are displaceably guided on horizontal rails 17 in the longitudinal direction L. In the exemplary embodiment, the rails 17 are L profiles, which are attached to the insides of the side walls 6 of the containers 2, parallel to and above the drying surface 13. The cross beams 16 can glide on the rails 17 or roll by way of rollers, for example. Multiple cross beams 16 are attached to the traction means 18, uniformly or non-uniformly distributed over the longitudinal direction L.

The cross beams 16 are pulled by cables or chains, serving as traction means 18, in the longitudinal direction L over the drying surface 13. A traction means 18 in a center of the cross beams 16 is conceivable, as are multiple traction means 18 distributed over the width B. In the exemplary embodiment, the linear conveyor 15 comprises two traction means 18 on inner sides of the side walls 6.

The traction means 18 are guided so as to revolve over two drying surfaces 13 in each case, which are disposed on top of one another. For this purpose, deflection wheels 19 are non-rotatably disposed in the first container 9 and in the last container 10, on a rotatably mounted shaft 20 that is disposed transversely to the longitudinal direction L, about which the traction means 18 are deflected, so that the traction means 18 are guided in one direction over one drying surface 13, and back over a drying surface 13 disposed therebeneath. The cross beams 16 are also deflected at the traction means 18, which is to say at one end of the drying surface 13 are transferred onto the rails 17 of an upper drying surface 13, and at another end of the drying surfaces 13 are transferred onto the rails 17 of the drying surface 13 disposed therebeneath. The shafts 20 comprising the deflection wheels 19 form deflections 21 of the linear conveyors 15. FIG. 1 shows a first container 9, in which the deflections 21 of the linear conveyors 15 at one end of the device 1 and of the drying surfaces 13 can be seen.

The linear conveyors 15 are driven in each case at one of the shafts 20 by an electric motor or in another manner (not shown).

Pegs project downwardly and upwardly from the cross beams 16 of the linear conveyors 15 and serve as conveying elements 22, wherein the downwardly projecting conveying elements 22 end at a small distance of one or several millimeters, and preferably less than 1 cm, above the respective drying surface 13. Conveying elements 22 that make contact with the drying surfaces 13 and pass over the drying surfaces 13 are also possible. After deflection, the upwardly projecting conveying elements 22 project downwardly toward the drying surface 13 then located therebeneath.

The conveying elements 22 can also comprise transversely or obliquely positioned plates, paddles, plow blades or the like for loosening, turning, distributing transversely across the width of the drying surface 13, and conveying the sewage sludge in the longitudinal direction L (not shown).

During the movement of the cross beams 16 in the longitudinal direction L, the conveying elements 22 “plow through” the sewage sludge, distribute it across the width B of the drying surfaces 13, turn it, loosen it, and successively convey the sewage sludge in the longitudinal direction L over the drying surfaces 13. The linear conveyors 15 can be operated continuously or with interruptions.

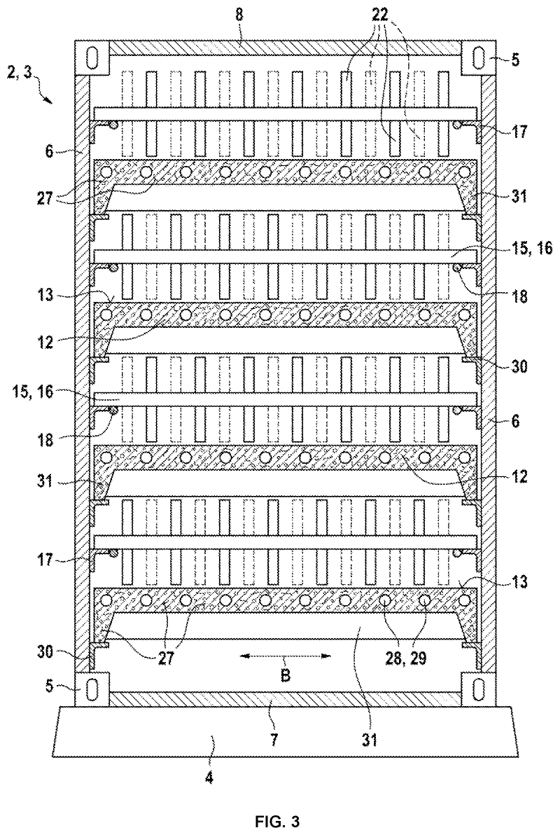

The conveying elements 22 are disposed spaced apart, next to one another, at the cross beams 16, wherein the conveying elements 22 are laterally offset at a cross beam 16 and, as seen in the longitudinal direction L, are thus disposed in gaps between the conveying elements 22 of another cross beam 16. FIG. 3 shows, by way of dotted lines, conveying elements 22 of another cross beam 16 which are disposed in the gaps between the conveying elements 15 of a cross beam 16.

In the first container 9 and in the last container 10, the drying surfaces 13, on which the sewage sludge is conveyed to the respective end, terminate in front of the respective drying surfaces 13 disposed therebeneath, on which the sewage sludge is conveyed back, so that, at the end of one drying surface 13, the sewage sludge drops onto the drying surface 13 disposed therebeneath.

The first and uppermost container 9 of the device 1, which is shown in FIG. 2, includes an opening as a loading point 23 for the sewage sludge in the ceiling 8 thereof. The first and lowermost container 9 can likewise include an opening in the floor 7 thereof, serving as a discharge point 24 for the sewage sludge, or the sewage sludge drops out of the first and lowermost container 9 from the lowermost drying surface 13 at the end face. In the exemplary embodiment, the first and lowermost container 9 comprises a cross channel 25, into which the sewage sludge drops at the end from the lowermost drying surface 13, and a screw conveyor 26, which is disposed in the cross channel 25 and by way of which the sewage sludge is removed from the device 1 through an opening in the side wall 6 of the container 9, serving as a discharge point 24.

In the exemplary embodiment, the slabs 12, the upper sides of which form the drying surfaces 13, are made of concrete, which is reinforced with glass fibers, synthetic fibers and/or stone fibers. The fibers form a rust-proof reinforcement 27 for the slabs 12. Since the reinforcement 27 does not rust, this does need to be covered by the concrete, as does a rusting steel reinforcement. The slabs 12 can therefore be thin.

The slabs 12 comprise pipes, as the heating lines 28, which are connected to one another in the intermediate spaces between the slabs 12 by sleeves, corrugated pipes or the like. In general, the heating lines 28 in the slabs 12 can also be interpreted as a heating device 29 of the drying surfaces 13. The slabs 12 are placed onto L profiles 30, which are attached to the insides of the side walls 6 of the containers 2 forming the modules 3 of the device 1 according to the invention.

The slabs 12 comprise transversely extending binding girders 31 for stiffening. In the exemplary embodiment, the slabs 12 additionally comprise longitudinally extending binding girders 31. The binding girders 31 can also run obliquely (not shown).

1. A device for drying sewage sludge, comprising at least one drying surface onto which the sewage sludge can be placed for drying, and comprising a linear conveyor, which comprises conveying elements that the linear conveyor moves in a longitudinal direction over the drying surface, wherein the device comprises modules, which are disposed behind one another in the longitudinal direction, the at least one drying surface continues through the modules, and the linear conveyor passes through the modules disposed behind one another.

2. The device according to claim 1, wherein the device comprises a plurality of drying surfaces which are disposed on top of one another and onto which the sewage sludge can be placed for drying, the device comprises a respective revolving linear conveyor for two drying surfaces disposed on top of one another, which comprises conveying elements that the linear conveyor moves in a longitudinal direction over the two drying surfaces disposed on top of one another and in opposite directions on the two drying surfaces, the device comprises modules, each of which comprises a plurality of drying surfaces disposed on top of one another, the modules are disposed behind one another in the longitudinal direction, the drying surfaces continue through the modules, the linear conveyor passes through the modules disposed behind one another, and the linear conveyor comprises a deflection in a first module and a deflection in a last module of the modules disposed behind one another.

3. The device according to claim 1, wherein the modules comprise standard containers.

4. The device according to claim 1, wherein the modules are disposed on top of one another.

5. The device according to claim 1, wherein the conveying elements take up a fraction of a width of the drying surfaces, and the conveying elements are distributed over the width of the drying surfaces.

6. The device according to claim 1, wherein the at least one drying surface comprises a heating device.

7. The device according to claim 1, wherein the at least one drying surface comprises heating lines or heating wires.

8. The device according to claim 7, wherein the at least one drying surface is subdivided in a modular manner in the longitudinal direction, and the heating lines are connected at the subdivisions of the at least one drying surface.

9. The device according to claim 1, wherein the at least one drying surfaces is detachably disposed in the modules.

10. The device according to claim 1, wherein the at least one drying surfaces comprises slabs, the upper sides of which form the at least one drying surface, and the slabs comprise a rust-proof reinforcement.

11. The device according to claim 1, wherein the at least one drying surface comprises slabs, the upper sides of which form the at least one drying surfaces, and the slabs comprise a binding girder.

12. The device according to claim 1, wherein the at least one drying surface is fluid-tight.

13. The device according to claim 1, wherein the first module comprises a loading point and/or a discharge point for the sewage sludge.
